(19) United States
(12) Patent Application Publication
(10) Pub. No.: US 2025/0217005 A1
(43) Pub. Date: Jul. 3, 2025

(54) METHOD AND APPARATUS FOR GENERATING SPECIAL EFFECT ICON, DEVICE, AND STORAGE MEDIUM

(71) Applicant: Beijing Zitiao Network Technology Co., Ltd., Haidian District, Beijing (CN)

(72) Inventors: Zhanhong YE, Beijing (CN); Hui FANG, Beijing (CN); Xunpeng YIN, Beijing (CN)

(21) Appl. No.: 18/853,381

(22) PCT Filed: Mar. 7, 2023
(86) PCT No.: PCT/CN2023/079964

§ 371 Date: Oct. 1, 2024

(30) Foreign Application Priority Data
Apr. 2, 2022 (CN) 202210351905.8

(51) Int. Cl. G06F 3/04817; G06F 3/0482; G06F 3/04845

(52) U.S. Cl. CPC G06F 3/04817; G06F 3/0482; G06F 3/04845

(57) ABSTRACT

A method for generating an effect icon, an electronic device, and a storage medium are provided. The method includes: in response to an icon production operation for a target effect, displaying an icon production window for the target effect; receiving a picture selection operation and acquiring a selected original picture, the picture selection operation being selecting one picture in the icon production window; and processing the original picture, displaying a processed target picture, and using the processed target picture as a target effect icon, the target picture being a superposition of the original picture and an effect result corresponding to the target effect.

The present application claims priority of Chinese Patent Application No. 202210351905.8 filed on Apr. 2, 2022 to Chinese Patent Office, the disclosure of which is incorporated in the present application by reference in its entirety.

### TECHNICAL FIELD

Embodiments of the present disclosure relate to the technical field of software production and for example, relate to a method and apparatus for generating an effect icon, a device, and a storage medium.

### BACKGROUND

The diversification of functions of intelligent terminals also has gradually enriched people's entertainment forms. Compared with the user simply using the cameras in the terminal to shoot images (for example, photos or videos), the user hope that more functions can be reflected in the image shooting process, such as live broadcasting, short videos, that have already appeared. Adding effects in the process of taking photos, live broadcasting or short videos has become a demand and habit for more and more users.

### SUMMARY

Embodiments of the present disclosure provide a method and apparatus for generating an effect icon, a device, and a storage medium.

In a first aspect, embodiments of the present disclosure provide a method for generating an effect icon. The method includes:
in response to an icon production operation for a target effect, displaying an icon production window for the target effect;
receiving a picture selection operation and acquiring a selected original picture, the picture selection operation being selecting one picture in the icon production window; and
processing the original picture, displaying a processed target picture, and using the processed target picture as a target effect icon, the target picture being a superposition of the original picture and an effect result corresponding to the target effect.

In a second aspect, embodiments of the present disclosure provide an apparatus for generating an effect icon. The apparatus includes:
an initial display module, configured to, in response to an icon production operation for a target effect, display an icon production window for the target effect;
a first receiving module, configured to: receive a picture selection operation, and acquire a selected original picture, the picture selection operation being selecting one picture in the icon production window; and
a display module, configured to: process the original picture, display a processed target picture, and use the processed target picture as a target effect icon, the target picture being a superposition of the original picture and an effect result corresponding to the target effect.

In a third aspect, embodiments of the present disclosure provide an electronic device. The electronic device includes:
one or more processors;
a storage apparatus, configured to store one or more programs,
when the one or more programs are executed by the one or more processors, the one or more processors is enabled to implement the method for generating the effect icon of any embodiment of the present disclosure.

In a fourth aspect, embodiments of the present disclosure provide a computer readable storage medium. A computer program is stored on the computer readable storage medium, and when the computer program is executed by a processor, the method for generating the effect icon of any embodiment of the present disclosure is implemented.

### BRIEF DESCRIPTION OF DRAWINGS

The following is a brief introduction to the drawings to describe the embodiment. The attached drawings introduced are only part of the attached drawings of the embodiments to be described in the present disclosure, not all of the attached drawings. On the premise of not having creative work, other attached drawings can be obtained according to these attached drawings.

FIG. 1 is a schematic diagram of a flow of a method for generating an effect icon, as provided by Embodiment I of the present disclosure;

FIG. 2 is a schematic diagram of a flow of a method for generating an effect icon, as provided by Embodiment II of the present disclosure;

FIG. 2A illustrates a flow chart of an instance of target picture determination in the method for generating the effect icon, as provided by this Embodiment II;

FIG. 2B illustrates a result display diagram of a generated target effect icon in the method for generating the effect icon, as provided by this embodiment;

FIG. 2C illustrates a flow chart of an example of the method for generating the effect icon, as provided by this embodiment;

FIG. 3 is a structural schematic diagram of an apparatus for generating an effect icon, as provided by Embodiment III of the present disclosure; and

FIG. 4 is a structural schematic diagram of an electronic device, as provided by Embodiment IV of the present disclosure.

### DETAILED DESCRIPTION

Generally, the effect used by the user is substantially directly integrated in related application software and in order to satisfy increasing use demands of the user for effect, effect production tools for the user to perform effect production are emerged. In performing the effect production by using the effect tools, the user often needs to add effect icons to produced effect.

An icon adding mode is substantially that the user directly uploads pictures or the user finds pictures from material pictures provided by the production tools to use as effect icons. Icons formed in this mode are often not highly associated with the effect produced by the user, resulting in that it is difficult to know the effect produced by the user through the effect icons and the effect production result is influenced; and if the user wants to provide the effect icons related to the effect, the user needs to spend long time performing relatively fussy production, resulting in that the effect production investment is increased.

In consideration of the case above, embodiments of the present application provide a method and apparatus for generating an effect icon, a device, and a storage medium.

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units. It should be noted that modifications of “one” and “more” mentioned in the present disclosure are schematic rather than restrictive, and those skilled in the art should understand that unless otherwise explicitly stated in the context, it should be understood as “one or more”.

Names of messages or information interacted among multiple apparatuses in the embodiments of the present disclosure are merely used for the illustrative purpose, but not used for limiting the scope of these messages or information.

### Embodiment I

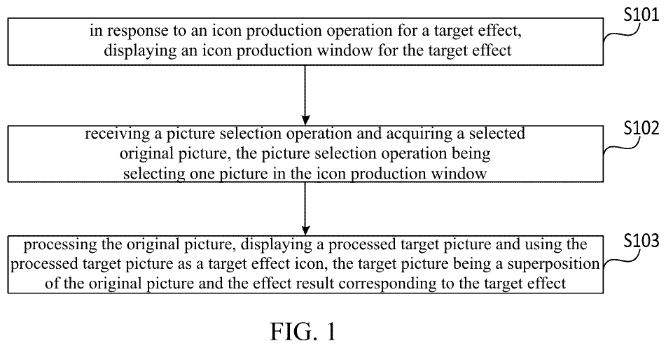

FIG. 1 is a schematic diagram of a flow of a method for generating an effect icon, as provided by Embodiment I of the present disclosure. In this embodiment, the effect icon can be generated in the effect production, the method can be executed by an apparatus for generating an effect icon, and the apparatus can be implemented by software and/or hardware and can be configured in a terminal and/or a server to implement the method for generating the effect icon in the embodiment of the present disclosure.

It should be illustrated that the method for generating the effect icon, as provided by this embodiment, can be used as a functional plug-in in an effect production tool, which can execute a generation logic of the effect icon by corresponding triggering after the effect production tool is started up to proceed to a related function of effect production.

As illustrated in FIG. 1, a method for generating an effect icon, as provided by this Embodiment I, can include:
S101: in response to an icon production operation for a target effect, displaying an icon production window for the target effect.

In this embodiment, this step can be regarded as the response to the effect icon production operation triggered by a user, and the icon production operation can be regarded as an operation of triggering an effect icon production function and for example, can be an operation of starting up and triggering an effect icon production function option in the effect production tool; and the target effect can be regarded as an effect to be produced or being produced by the user. The icon production window can be understood as an interface window associated with effect icon production performed on the target effect.

In this step, the triggered icon production operation can be responded to, then icon production window can be rendered and obtained by a corresponding window rendering component, and the icon production window is presented on a device screen. For example, the icon production window can include a picture selection region required for icon production, a display region for the produced icon, and for another example, a menu region of related function options in the icon production.

It should be illustrated that in this embodiment, the effect icon production on the target effect is equivalent to one of the production flows in the target effect production. Before the effect icon production is performed, in this embodiment, firstly, the effect production tool can need to be triggered and started up by a certain triggering means, after the effect production tool is started up, firstly, a main effect production window is entered, and then by a functional region or an operation option displayed in the main effect production window, material selection, parameter configuration, etc. of the to-be-produced target effect can be implemented.

It can be known that the presented main effect production window can include related functional regions for the effect production, for example, a selection region of a material required for effect production and a configuration region of a parameter required for effect production, and for another example, a menu display region of each operation option involved in the effect production, and the operation option for the effect icon production can be presented in the menu display region. An effect preview interface for displaying the effect production process can also be presented in the main effect production window, and all effect results corresponding to the target effect in the effect production can be presented by the effect preview interface.
S102: receiving a picture selection operation and acquiring a selected original picture. The picture selection operation is selecting one picture in the icon production window.

In this embodiment, after the icon production window is presented by the above-mentioned step S101, the production logic of the effect icon is implemented by this step and the step S103 mentioned below. For example, in the icon production window, an operation option related to icon selection is presented and by triggering the icon selection operation option, the picture selection operation can be received by this step.

It can be known that an operation button for picture import can be displayed in the icon production window, a template picture option pre-integrated by the effect production tool can also be displayed, the picture selection operation can be performed in the icon production window by the user, and the user can enter a local path by triggering the picture import button and locally select a picture required for icon production; and the user can also enter an interface of a template picture by triggering selection of the template picture and select a picture required for icon production from the interface.

In this step, in response to the picture selection operation triggered by the user, the picture selected in the mode above by the user can be obtained. In this embodiment, the selected picture is marked as the original picture required for icon production.
S103: processing the original picture, displaying a processed target picture and using the processed target picture as a target effect icon. The target picture is a superposition of the original picture and the effect result corresponding to the target effect.

This step can be regarded as a step responding to the above-mentioned step S102. In this step, superposition processing of the effect result can be performed on the original picture after the selected original picture is obtained by S102. In this embodiment, superposition processing of the effect result corresponding to the target effect is performed on the original picture. The effect result corresponding to the target effect can be understood as a rendering result that can be presented after production of the target effect expected to produce by the user is completed or is performed to a certain stage.

It needs to be illustrated that in the effect production tool, production of the target effect mainly depends on a created effect production process; and after the user provides the production material required for production of the target effect and the parameter required for production, the effect production logic related to the target effect can be executed by the effect production process.

In this embodiment, as one of implementations, in this step, the original picture can be provided to the effect production process for performing target effect production, an original material for target effect production is replaced, and the effect production process can suspend the effect production on the original material and turn to perform effect production on the basis of the original picture, so that the effect result which is originally to be presented on the provided material is superposed on the original picture and finally, the effect result which the user expects the target effect to have is superposed on the output picture. In this step, the output target picture can be displayed and used as the target effect icon, and the target effect icon includes the effect result of the target effect, so that association is established between the target effect icon and the target effect.

Based on the description above, it can be seen that in this step, processing on the original picture is equivalent to reuse of the existing effect production logic, and a new processing execution logic does not need to be additionally set for generation of the target effect icon, so that the input of additional performance cost is avoided.

According to the method for generating the effect icon, as provided by this Embodiment I, in the effect icon production process, the effect icon with high correlation with the produced effect can be generated by processing the selected picture, so that the result of the effect produced by the user can be rapidly known by the effect icon and the production effect result is promoted; the effective submission of the produced effect to an effect verification platform is also ensured; and meanwhile, compared to the related art in which more time and manpower are spent to produce a highly associated effect icon, in this embodiment, as long as the user selects the original picture, superposition processing from the production effect result to the original picture can be rapidly implemented, and then the icon associated with the produced effect can be obtained. By the implementation method, the icon production efficiency is effectively promoted and the production input of the effect is reduced.

### Embodiment II

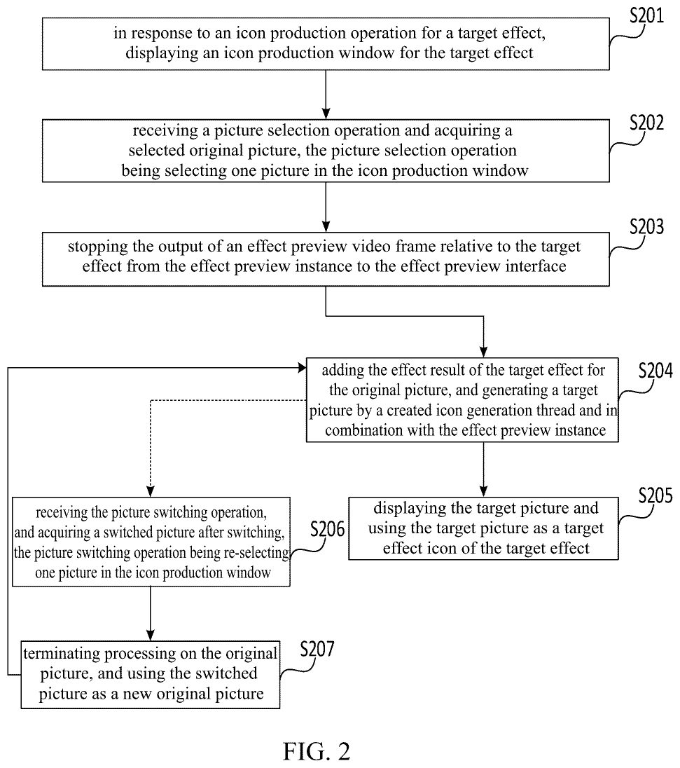

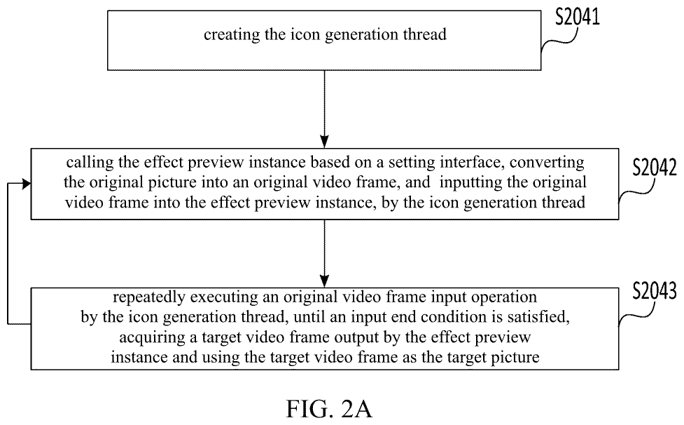

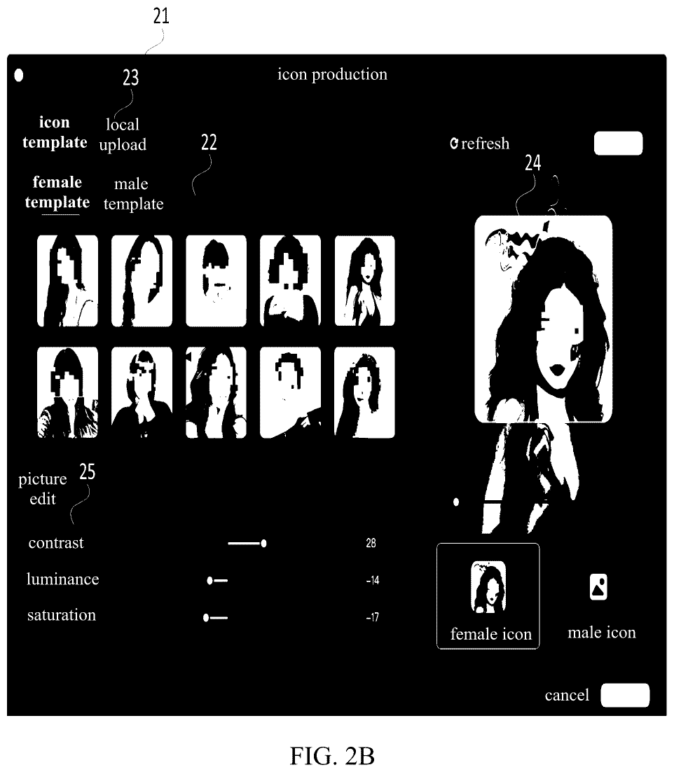

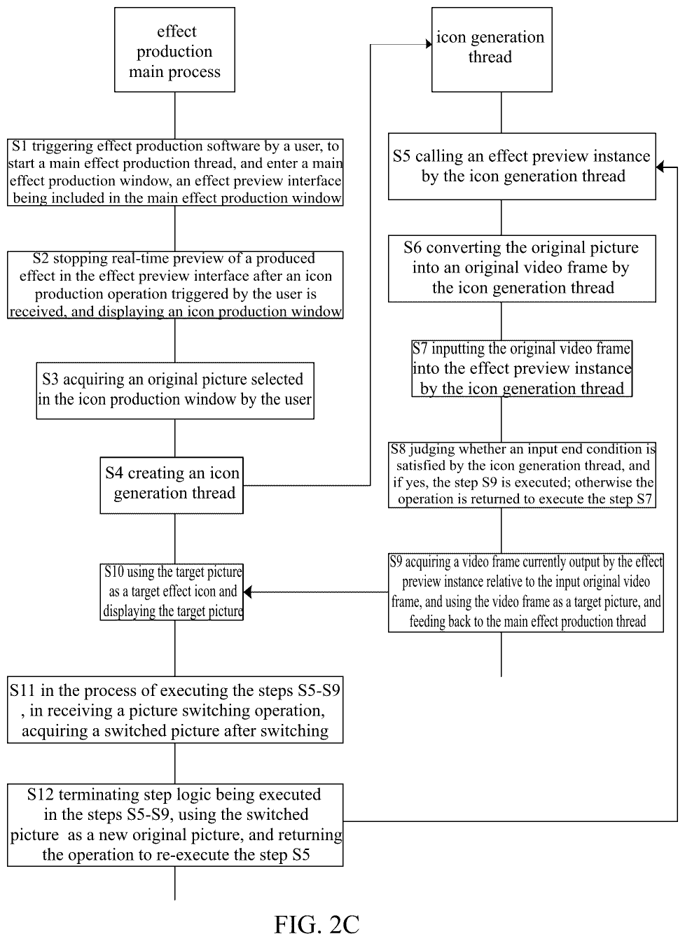

FIG. 2 is a schematic diagram of a flow of a method for generating an effect icon, as provided by Embodiment II of the present disclosure. This Embodiment II is adjusted on the basis of the embodiment above. In this embodiment, an effect preview interface is included in the main effect production window for the target effect and the effect preview interface is presented through a pre-created effect preview instance.

On the basis of the adjustment above, processing the original picture, displaying the processed target picture, and using the processed target picture as the target effect icon can be: adding the effect result of the target effect for the original picture by a created icon generation thread and in combination with the effect preview instance, and generating a target picture; and displaying the target picture and using the target picture as the target effect icon of the target effect.

Meanwhile, on the basis of the adjustment above, before adding the effect result of the target effect for the original picture by the created icon generation thread and in combination with the effect preview instance and generating the target picture, it adds: stopping the output of an effect preview video frame relative to the target effect from the effect preview instance to the effect preview interface.

In addition, in the process of processing the original picture, this embodiment can further add: receiving a picture switching operation and acquiring a switched picture after switching, the picture switching operation being reselecting one picture in the icon production window; terminating processing on the original picture and using the switched picture as a new original picture; and re-executing processing on the original picture, displaying the processed target picture, and using the processed target picture as the target effect icon.

It should be known that in this embodiment, the effect production tool is equivalent to the effect production application software, and the user can enter the main effect production window after starting up the effect production application software. The main effect production window can be used for production of the target effect in this embodiment. In one example, an effect preview interface is displayed in a related region of the main effect production window, and each effect video frame of the target effect, which is formed in the effect production process, is previewed in real time through the effect preview interface, wherein previewing in real time is equivalent to providing the effect result of the currently produced target effect for the user in a form of video streaming.

Continuing from the description above, real-time preview of the effect result in the effect preview interface can depend on the effect preview instance in the effect production tool. For example, a background picture adopted in the target effect production can be read through the effect preview instance, and the background picture can also be handed over to an effect production function (which can be operated in a form of the effect production process) on the bottom layer to be added with the effect result; and then, the effect preview instance can acquire the picture added with the effect result, and this picture can be displayed for the user as one video frame.

It can be seen that the effect preview instance mentioned in this embodiment possesses the ability of reading information of the original picture, handing over the information of the original picture to the effect production function to perform effect adding production, and acquiring the picture with the effect result from the effect production function, i.e., the effect picture/video frame with the effect result can be acquired through the effect preview instance. In this embodiment, when generation of the effect icon is implemented, it is required that the generated effect icon should contain contents associated with the produced effect. In order to meet the requirement above, this embodiment considers to re-use the above-mentioned effect preview instance to add the effect result included by the target effect on the original picture.

As illustrated in FIG. 2, a method for generating an effect icon, as provided by this Embodiment II, includes operations as follows:
S201: in response to an icon production operation for a target effect, displaying an icon production window for the target effect.

For example, a user enters a generation logic of the effect icon in an effect production application software by triggering an icon production function button. Triggering on the icon production function button by the user can be regarded as one time of icon production operation for the target effect, which is performed by the user. In this step, the icon production operation can be responded to and on the basis of a main effect production window, the icon production window for the target effect is presented.
S202: receiving a picture selection operation and acquiring a selected original picture. The picture selection operation is selecting one picture in the icon production window.

This step is equivalent to implementation of selection of a background picture required for the effect icon production, and the selected picture is used as an original picture for the effect icon production. The original picture can be a picture selected from a local device by the user, or can be a picture directly selected from a provided background picture template by the user.

After the original picture is acquired by this step, the generation of the effect icon can be implemented by the following mentioned step in this embodiment.
S203: stopping the output of an effect preview video frame relative to the target effect from the effect preview instance to the effect preview interface.

In this embodiment, the effect preview video frame can be understood as a video frame output in real time by the effect preview instance when the produced target effect is presented on the effect preview interface.

In this embodiment, it is considered to generate the effect icon in a mode of reusing the effect preview instance. However, in the existing application implementation of the effect production, the effect preview instance is mainly used for performing effect result real-time preview of the produced effect. If it is intended to reuse the effect preview instance for generating the effect icon, before the effect preview instance is reused, a real-time preview logic of the effect preview instance needs to be suspended first by the operation in this step.

For example, when this step is executed, a main execution process for the effect production can send a preview stop signal to the effect preview instance, and then the effect preview instance can suspend the output of the effect preview video frame on the basis of this stop signal and proceed to an idle state so as to provide services for generation of the effect icon better. Similarly, it can be understood that in this embodiment, after the effect preview instance completes execution on generation of the effect icon, a preview continuing signal can be sent to the effect preview instance again, so that the effect preview instance restarts the real-time preview of the effect result.

In this embodiment, by the execution logic of S203, the influence on the run efficiency when the effect preview instance performs generation of the effect icon can be reduced.
S204: adding the effect result of the target effect for the original picture, and generating a target picture by a created icon generation thread and in combination with the effect preview instance.

In this embodiment, the main execution process for the effect production is not directly adopted to participate in generation of the effect icon, on the premise of the main execution process, a thread special for performing the icon generation operation is re-created for implementing icon generation, and in this embodiment, this thread is marked as an icon generation thread. The operation of this step can be executed by the created icon generation thread, wherein the target picture can be understood as a picture containing the effect result related to the produced target effect after the original picture is processed.

For example, the effect preview instance can be reused through the icon generation thread, then on the basis of the reused effect preview instance, an input original icon can be transferred to the effect production function so as to add the effect result which the target effect has on the original picture, and after that, the icon generation thread can acquire a target picture output by the effect preview instance. The target picture is added with the effect result of the target effect.

In one example, FIG. 2A illustrates a flow chart of an instance of target picture determination in the method for generating the effect icon, as provided by this Embodiment II. As illustrated in FIG. 2A, the implementation steps of the above-mentioned step S204 “adding the effect result of the target effect for the original picture and generating the target picture by the created icon generation thread and in combination with the effect preview instance” illustrates:
S2041: creating the icon generation thread.

In this embodiment, by the main execution process for the effect production, after it is determined to perform the generation operation of the effect icon, this step can be executed to create one new thread for performing a related logic of the icon generation. In this embodiment, the newly created thread is marked as the icon generation thread.
S2042: calling the effect preview instance based on a setting interface, converting the original picture into an original video frame, and inputting the original video frame into the effect preview instance by the icon generation thread.

In this embodiment, the icon generation operation can be executed by the newly created icon generation thread. Firstly, the icon generation thread can execute this step to call the to-be-reused effect preview instance and can call by a preset instance interface; and then, the original picture is input into the called effect preview instance. In consideration of a case that an input data format of the effect preview instance is a video frame format, before the original picture is input into the effect preview instance, the icon generation thread can perform format conversion on the original picture so as to acquire an original video frame.
S2043: repeatedly executing an original video frame input operation by the icon generation thread, until an input end condition is satisfied, acquiring a target video frame output by the effect preview instance and using the target video frame as the target picture.

Based on the above-mentioned analysis on the working principle of the effect preview instance in this embodiment, it can be known that the effect preview instance can transfer the received picture to the effect production function on the bottom layer to add the effect result, then acquire the picture in real time, which is added with the effect at a current moment by the effect production function, and output the picture added with the effect.

The effect production of the effect production function is one independent process; and the effect production is started after a to-be-produced picture (such as the original picture) is acquired for the first time, and then the effect production is continuously performed on the to-be-produced picture until all the effect results expected by the user are added on the to-be-produced picture. In addition, the effect production process of the effect production function actually is also a continuous and progressive process, and the effect results which can be added on the to-be-produced picture by the effect production function will be gradually increased with passage of the production time.

Continuing from the description above, on the basis that the effect production function has the properties above, if the production of the effect production function is still on a pre-production stage when the original picture is input into the effect preview instance, a to-be-output picture which can be acquired currently by the effect preview instance can be not added with many effect results, and at the moment, contents contained on the to-be-output picture can not be able to present the effect results related to the produced target effect.

On this basis, this embodiment considers that the input operation from the original video frame to the effect production function is repeatedly executed by the icon generation thread, until the input end condition is satisfied, and the output video frame is acquired from the effect preview instance. In this embodiment, the video frame is marked as the target video frame and used as the target picture generated by the icon generation thread, wherein the target video frame is a picture in which the effect result of the target effect is superposed on the original picture.

In this embodiment, the input end condition as the cycle end condition above can be that an input number of times from the original video frame to the effect preview instance reaches a set threshold; the input end condition also can be that after the original video frame is input into the effect preview instance at a certain time, it is detected that the effect result contained in a to-be-output video frame in the effect preview instance can be associated with the target effect; the input end condition also can be that after the original video frame is input into the effect preview instance at a certain time, a video frame output outwards by the effect preview instance reaches the effect result requested by the user.

As one embodiment of the above-mentioned step S2043 “repeatedly executing an original video frame input operation by the icon generation thread, until an input end condition is satisfied, acquiring a target video frame output by the effect preview instance and using the target video frame as the target picture”, this embodiment can be described as follows:

It can be known that this instance can be regarded as the logic implementation description when a comparison result between the input number of times and the set threshold is used as a set target of the input end condition.
a1: determining a corresponding cumulative input number of times by the icon generation thread, after the current input of the original video frame to the effect preview instance is executed.

In this embodiment, firstly, by the icon generation thread, after the input of the original video frame to the effect preview instance is executed, the cumulative input number of times can be determined based on this step, so that every time after the original video frame is input, the corresponding cumulative input number of times can be acquired.
b1: judging whether the cumulative input number of times reaches a set cumulative threshold, if yes, the step c1 is executed, otherwise the operation is returned to execute the above-mentioned step S2042.

In this embodiment, the comparison result between the cumulative input number of times and the set cumulative threshold can be used as the set target of the input end condition; when the cumulative input number of times is greater than the set cumulative threshold, it can be regarded that the end condition of cyclic input is satisfied currently, and thus, the subsequent step c1 can be executed; and when the cumulative input number of times is smaller than the set cumulative threshold, it can be regarded that the input end condition is not satisfied currently, and the input operation from the original video frame to the effect preview instance needs to be performed again by the above-mentioned step S2042.
c1: acquiring a video frame currently output by the effect preview instance and marking as the target video frame.

It can be known that in the process that the effect production function continuously performs effect production on the original picture, the effect preview instance can acquire a video frame participating in the effect production in real time, and can output the video frame outwards. After the cyclic input end condition is satisfied, in this step, the video frame output at a corresponding moment by the effect preview instance can be acquired and marked as the target video frame.

As another embodiment of the above-mentioned step S2043 “repeatedly executing an original video frame input operation by the icon generation thread, until an input end condition is satisfied, acquiring a target video frame output by the effect preview instance and using the target video frame as the target picture”, this embodiment can be described as follows:

It can be known that this instance can be regarded as the logic implementation description when the input end condition is set based on association between the effect result contained in the video frame to be output by the effect preview instance and the target effect result.
a2: performing feature analysis on a current video frame correspondingly acquired by the effect preview instance after the current input of the original video frame to the effect preview instance is executed by the icon generation thread.

In this embodiment, similarly, after the input of the original video frame to the effect preview instance is executed by the icon generation thread, feature analysis can be performed on the corresponding current video frame on the basis of this step, and thus, every time after the original video frame is input, the current video frame taken from the effect production function by the effect preview instance can be analyzed, and feature information of the current video frame can be determined.
b2: judging whether the current video frame includes the effect result feature of the target effect, if yes, the step c2 is executed, otherwise the operation is returned to execute the above-mentioned step S2042.

In this embodiment, a matching result between the feature information of the acquired current video frame and the effect result feature of the target effect can be used as a setting target of the input end condition, and when the feature information includes the effect result feature of the target effect, it can be regarded that the cyclic input end condition is satisfied currently, and thus, the subsequent step c2 can be executed.

When the effect result feature included in the feature information cannot be matched with the effect result feature of the target effect, it can be regarded that the input end condition is not satisfied currently, and the input operation from the original video frame to the effect preview instance needs to be performed again by the above-mentioned step S2042.
c2: acquiring the current video frame and marking the current video frame as the target video frame.

Similarly, in the process of the effect production function continuously performing effect production on the original picture, the effect preview instance can acquire a video frame participating in the effect production in real time, and the video frame can be used as a current video frame taken at a corresponding moment by the effect preview instance. After the cyclic input end condition is satisfied, in this step, the current video frame can be acquired and marked as the target video frame.

As yet another embodiment of the above-mentioned step S2043 “repeatedly executing an original video frame input operation by the icon generation thread, until an input end condition is satisfied, acquiring a target video frame output by the effect preview instance and using the target video frame as the target picture”, this embodiment can be described as follows:

It can be known that this instance can be regarded as the logic implementation description when the input end condition is set based on a user behavior.
a3: acquiring and displaying a current video frame output after the effect preview instance receives the currently input original video frame by the icon generation thread,

In this embodiment, after the input of the original video frame to the effect preview instance is executed by the icon generation thread, a video frame taken from the effect production function by the effect preview instance relative to the current input operation can be acquired based on this step, and the video frame is marked as the current video frame and can be displayed in the related region of the icon production window for the user to view.

For example, one video frame display sub-window can be set in the icon production window; the current video frame acquired by this step can be displayed in the video frame display sub-window; and with respect to the displayed video frame, in this embodiment, two button components can be arranged in the video frame display sub-window, one button component can be used as a selection button for selecting the current video frame, and the other button component can be used as an input continuing button for triggering subsequent re-input of the original video frame.
b3: judging whether a selection operation of the user relative to the current video frame is received, if yes, the step c3 is executed, otherwise after an input continuing operation triggered by the user is received, the operation is returned to execute the above-mentioned step S2042.

In this embodiment, after the current video frame is displayed, it can be monitored whether the selection operation, such as an operation of triggering the selection button above illustrated, of the user relative to the current video frame is received; and if the selection operation is received, it can be regarded that the cyclic input end condition is satisfied currently, and thus, the subsequent step c3 can be executed.

If the selection operation is not received, when the user triggers the input continuing operation, such as triggering the input continuing button above illustrated, it can be regarded that the input end condition is not satisfied currently, and the input operation from the original video frame to the effect preview instance needs to be performed again by the above-mentioned step S2042.
c3: marking the current video frame as the target video frame.

After the cyclic input end condition is satisfied, in this step, the current video frame selected by the user can be marked as the target video frame.

It should be illustrated that the key of implementation of the above-mentioned step S204 lies in the cyclic input of the original video frame to the effect preview instance and the setting of the input end condition. In this embodiment, the original video frame cyclically input every time is the original picture received in the above-mentioned step S202.

With respect to the setting of the input end condition, in addition to several instances illustrated above by this embodiment, there are also other setting modes. For example, in consideration of a case that the effect production function can acquire the video frame with more effect results after being operated for a period of time, the video frame corresponding to the previous input operation from the original video frame to the effect preview instance can not have high practical value, and thus, in the process of executing the icon generation thread, the feature analysis is performed on the correspondingly to-be-input video frame or the correspondingly to-be-input video frame is displayed for the user without beginning from the input of the original video frame. This embodiment can further consider combination of multiple conditions.

Based on the analysis above, this embodiment can consider setting the input end condition by combining the cumulative input number of times with the feature analysis, or setting the input end condition by combining the cumulative input number of times with a display occasion of the video frame.

For example, when it is determined that the cumulative input number of times reaches an intermediate threshold, feature analysis can be performed on the video frame subsequently to be output by the effect preview instance, and when a feature analysis result satisfies a matching condition of the effect result, the input cycle of the original video frame is ended; and for another example, similarly, when it is determined that the cumulative input number of times reaches the intermediate threshold, the video frame subsequently output by the effect preview instance can be displayed to the user, and after the selection operation of the user for a certain video frame is received, the input cycle of the original video frame is received.
S205: displaying the target picture and using the target picture as a target effect icon of the target effect.

Continuing from the execution logic of the above-mentioned step S204, after the target picture is determined by the icon generation thread, the icon generation thread can feed back the target picture to a main effect production thread, then the main effect production thread can display the target picture fed back by the icon generation thread by this step, and the target picture can also be used as the target effect icon formed by icon production.

It should be illustrated that this embodiment also provides related components of parameter configuration in the icon generation window relative to the generated target effect icon for performing a parameter control operation on a set parameter configuration component. In this embodiment, in response to the parameter control operation triggered by the user, some attribute parameters of the target effect icon are adjusted. The adjustable attribute parameters include a contrast, luminance, saturation, and the like of the effect icon.

For example, FIG. 2B illustrates an effect display diagram of the generated target effect icon in the method for generating the effect icon, as provided by this embodiment. As illustrated in FIG. 2B, one icon production window 21 is displayed, and in the icon production window, a background picture template 22 is displayed for the user to select the original picture therein; and a button of local upload 23 is also displayed for the user to select the original picture from a local device. Meanwhile, a target effect icon 24 which the icon production is completed is displayed for the user in a set region of the icon production window.

It can be seen that the original picture corresponding to the target effect icon 24 in FIG. 2B exists in the background picture template 22, and compared to the original picture, the generated target effect icon 24 contains a part or all of the effect results of the effect produced by the user. The effect result presented by the target effect icon 24 are manifested as filtering on image characters, adding of lip makeup and eye makeup on the image characters, and also rendering on an image background. Compared to the original picture, after the target effect icon 24 contains the effect results of the produced effect, association between the effect icon and the produced effect is reflected better.

In addition, by the icon production window 21 displayed in FIG. 2B, it can also be determined that in this embodiment, when the effect icon is generated, different types of users are distinguished, for example, the male user and the female user are distinguished by gender. The example above of this embodiment shows humanization and diversification of the effect production application software better. Meanwhile, a picture editing region 25 for performing icon parameter editing is also included in the icon production window 21.

In this embodiment, it is considered to independently execute the generation logic of the icon by the newly created icon generation thread, which saves the resource occupancy of the main effect production thread. Therefore, when the icon generation thread executes the icon generation operation, the main effect production thread can still normally respond to other operations triggered by the user so as to avoid the state blockage of the main effect production thread and meanwhile, also implement the unperceptive operation of the user in the effect production application.

It should be illustrated that this embodiment already can implement generation of the effect icon by the above-mentioned step. The implementation logic of the following mentioned steps S206 and S207 are mainly performed in the process of processing the original picture, it can exist in parallel to the above-mentioned step S204, or can be started for execution in the process of executing the step S204. Execution occasions of the implementation logic of the steps S206 and S207 are mainly related to an occasion when the user triggers the picture switching operation.
S206: receiving the picture switching operation, and acquiring a switched picture after switching. The picture switching operation is re-selecting one picture in the icon production window.

In this embodiment, in the implementation of performing icon generation by the icon generation thread, the main effect production thread can continuously monitor operations of the user in functional software. When the main effect production thread monitors that the user re-selects one picture in the icon production window, execution of this step can be triggered, i.e., the picture switching operation triggered by the user is received, and in response to this operation, the switched picture corresponding to the picture switching operation is acquired; and then the service logic of the step S207 can be continued for execution.
S207: terminating processing on the original picture, using the switched picture as a new original picture, and returning the operation to re-execute the step S204.

In this embodiment, the implementation logic of this step is also executed by the main effect production thread. It can be that after the switched picture is acquired, processing on the original picture is ended by terminating the icon generation operation of the created icon generation thread above; then the newly acquired switched picture can be used as a new original picture; and then the operation is returned to the step S204 to re-create a new icon generation thread, and the generation operation of the target picture is independently performed again by the newly created icon generation thread.

For terminating processing on the original picture, this embodiment can include the following mentioned implementation steps: searching the created icon generation thread for executing processing on the original picture, and modifying a thread run parameter in the icon generation thread; and in a case of detecting a change of the thread run parameter by the icon generation thread, terminating the thread run.

A main effect execution thread can search a currently operated icon generation thread, and the icon generation thread can be regarded as a created thread required for processing the original picture; then this main effect production thread can send a parameter modification instruction to the determined icon generation thread so as to modify a thread run parameter for controlling the thread run in the icon generation thread; and when the icon generation thread detect the change of the thread run parameter, the operation of the icon generation thread can be terminated.

According to the method for generating the effect icon, as provided by this Embodiment II, before the effect icon generation logic is executed, the stop operation of the effect preview instance relative to real-time preview is added, which reduces influence on the run efficiency when the effect preview instance performs generation of the effect icon; meanwhile, the process of processing the original picture is described, so that adding the effect result on the original picture is independently implemented by the created icon generation thread, thereby saving the resource occupancy of the main effect production thread, avoiding the state blockage of the main effect production thread, and meanwhile, also implementing the unperceptive operation of the user in the effect production application; and furthermore, it is also added with the logic implementation of terminating the current operation of generating the effect icon when receiving the switched picture in the process of processing the original picture, and turning to perform effect icon generation relative to the switched picture. The technical implementation also reflects the unperceptive operation of the user in the effect production application, and meanwhile, the logic implementation of terminating the original thread also avoids the resource waste caused by discarding thread run.

In order to better understand the method for generating the effect icon, as provided by this embodiment, this embodiment illustrates one application example to describe the generation process of the effect icon. For example, FIG. 2C illustrates a flow chart of an example of the method for generating the effect icon, as provided by this embodiment. As illustrated in FIG. 2C, the method for generating the effect icon can include the steps as follows:
S1: triggering effect production software by a user, to start a main effect production thread, and enter a main effect production window. An effect preview interface is included in the main effect production window.
S2: stopping real-time preview of a produced effect in the effect preview interface after an icon production operation triggered by the user is received, and displaying an icon production window.
S3: acquiring an original picture selected in the icon production window by the user.
S4: creating an icon generation thread.

Execution bodies of the above-mentioned steps S1-S4 all are the main effect production thread.
S5: calling an effect preview instance by the icon generation thread.
S6: converting the original picture into an original video frame by the icon generation thread.
S7: inputting the original video frame into the effect preview instance by the icon generation thread.
S8: judging whether an input end condition is satisfied by the icon generation thread, and if yes, the step S9 is executed; otherwise the operation is returned to execute the step S7.
S9: acquiring a video frame currently output by the effect preview instance relative to the input original video frame, and using the video frame as a target picture, and feeding back to the main effect production thread.

It can be known that if the icon generation thread normally completes an icon generation operation, after the target picture is generated, the run of the thread can be ended.
S10: using the target picture as a target effect icon and displaying the target picture.
S11: in the process of executing the steps S5-S9, in receiving a picture switching operation, acquiring a switched picture after switching.
S12: terminating step logic being executed in the steps S5-S9, using the switched picture as a new original picture, and returning the operation to re-execute the step S5.

It should be illustrated that in this embodiment, after an icon production closing operation triggered by the user is received, e.g., a closing button of the icon production window is triggered, a production execution logic of the effect icon is ended.

Execution bodies of the above-mentioned steps S10-S12 can be regarded as the main effect production thread.

### Embodiment III

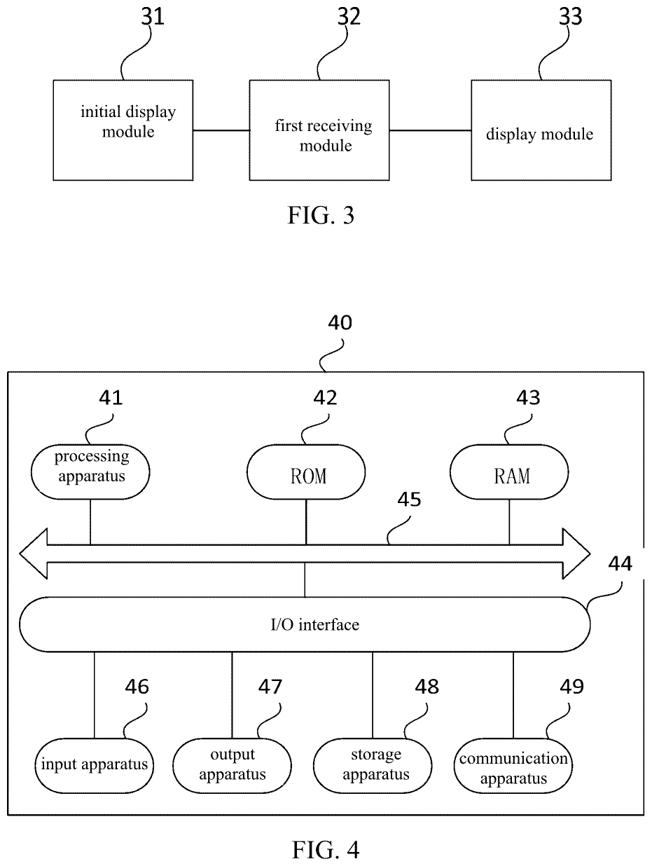

FIG. 3 is a structural schematic diagram of an apparatus for generating an effect icon, as provided by Embodiment III of the present disclosure. In this embodiment, the effect icon can be generated in the effect production, and the apparatus can be implemented by software and/or hardware and can be configured in a terminal and/or a server to implement the method for generating the effect icon in the embodiments of the present disclosure. The apparatus can include: an initial display module 31, a first receiving module 32, and a display module 33.

The initial display module 31 is configured to: in response to an icon production operation for a target effect, display an icon production window for the target effect;

The first receiving module 32 is configured to: receive a picture selection operation, and acquire a selected original picture, the picture selection operation being selecting one picture in the icon production window; and

The display module 33 is configured to: process the original picture, display a processed target picture, and use the processed target picture as a target effect icon, the target picture being a superposition of the original picture and an effect result corresponding to the target effect.

According to the apparatus for generating the effect icon, as provided by this Embodiment III, in the effect icon production process, the effect icon with high correlation with the produced effect can be generated by processing the selected picture, so that the result of the effect produced by the user can be rapidly known by the effect icon and the production effect result is promoted; the effective submission of the produced effect to an effect verification platform is also ensured; and meanwhile, compared to the related art in which more time and manpower are spent to produce a highly associated effect icon, in this embodiment, as long as the user selects the original picture, superposition processing from the production effect result to the original picture can be rapidly implemented, and then the icon associated with the produced effect can be obtained. By the implementation method, the icon production efficiency is effectively promoted and the production input of the effect is reduced.

On the basis of any one of the embodiments of the present disclosure, in one embodiment, an effect preview interface is included in a main effect production window for the target effect, and the effect preview interface is presented through a pre-created effect preview instance;

Correspondingly, the display module 33 includes:
a picture generation unit, configured to: add the effect of the target effect for the original picture and generate a target picture by a created icon generation thread and in combination with the effect preview instance; and
a picture display unit, configured to: display the target picture and use the target picture as the target effect icon of the target effect.

On the basis of any one of the embodiments of the present disclosure, in one embodiment, the picture generation unit includes:
a thread creation sub-unit, configured to: create the icon generation thread; and
an icon generation thread, configured to: call the effect preview instance based on a setting interface, convert the original picture into an original video frame, and input the original video frame into the effect preview instance.

The icon generation thread is further configured to: repeatedly execute an original video frame input operation until an input end condition is satisfied, acquire a target video frame output by the effect preview instance, and use the target video frame as the target picture.

The target video frame is a picture in which the effect result of the target effect is superposed on the original picture.

On the basis of any one of the embodiments of the present disclosure, in one embodiment, the icon generation thread can be configured to:
call the effect preview instance based on the setting interface, convert the original picture into the original video frame, and input the original video frame into the effect preview instance;
determine a corresponding cumulative input number of times, after the current input of the original video frame to the effect preview instance is executed;
if the cumulative input number of times does not reach a set cumulative threshold, re-execute an input operation from the original video frame to the effect preview instance; otherwise
acquire a video frame currently output by the effect preview instance and mark the video frame as the target video frame.

On the basis of any one of the embodiments of the present disclosure, in one embodiment, the icon generation thread can be configured to:
call the effect preview instance based on the setting interface, convert the original picture into the original video frame, and input the original video frame into the effect preview instance;
perform feature analysis on a current video frame correspondingly acquired by the effect preview instance, after the current input of the original video frame to the effect preview instance is executed;
when it is determined that an effect feature of the target effect is included in the current video frame, acquire the current video frame, and mark the current video frame as the target video frame; otherwise
re-execute the input operation from the original video frame to the effect preview instance.

On the basis of any one of the embodiments of the present disclosure, in one embodiment, the icon generation thread can be configured to:
call the effect preview instance based on the setting interface, convert the original picture into the original video frame, and input the original video frame into the effect preview instance;
acquire and display a current video frame output after the effect preview instance receives the currently input original video frame;
mark the current video frame as the target video frame when a selection operation of a user relative to the current video frame is received; otherwise
re-execute the input operation from the original video frame to the effect preview instance, after a continuous input operation triggered by the user is received.

On the basis of any one of the embodiments of the present disclosure, in one embodiment, the apparatus further can include: a preview stop module, configured to: before adding the effect of the target effect for the original picture and generating the target picture, by the created icon generation thread and in combination with the effect preview instance, stop the output of an effect preview video frame relative to the target effect from the effect preview instance to the effect preview interface.

On the basis of any one of the embodiments of the present disclosure, in one embodiment, the apparatus can further include:
a second receiving module, configured to: in the process of processing the original picture, receive a picture switching operation and acquire a switched picture after switching, the picture switching operation being re-selecting one picture in the icon production window;
a processing terminating module, configured to: terminate processing on the original picture and use the switched picture as a new original picture; and
a processing circulation module, configured to: re-execute processing on the original picture, display the processed target picture, and use the processed target picture as the target effect icon.

On the basis of any one of the embodiments of the present disclosure, in one embodiment, the processing terminating module can be configured to:
search the created icon generation thread for executing processing on the original picture and modify a thread run parameter in the icon generation thread; and
when a change of the thread run parameter is detected by the icon generation thread, end the thread run.

The apparatus can execute the method provided by any one of the embodiments of the present disclosure and has functional modules and beneficial effects corresponding to the execution method.

It should be noted that each unit and each module included by the apparatus are just partitioned according to functional logic, but not limited to the partitioning above, provided that corresponding functions can be achieved; and in addition, the specific name of each functional unit is also merely for facilitating mutual distinguishing, but is not intended to limit the scope of protection of the embodiments of the present disclosure.

### Embodiment IV

FIG. 4 is a structural schematic diagram of an electronic device provided by Embodiment IV of the present disclosure. With reference to FIG. 4 below, it illustrates a structural schematic diagram of an electronic device (e.g., a terminal device or a server in FIG. 4) 40 suitable for implementing the embodiments of the present disclosure. The terminal device in an embodiment of the present disclosure may include, but be not limited to, a mobile terminal such as a mobile phone, a notebook computer, a digital broadcasting receiver, a Personal Digital Assistant (PDA), a tablet personal computer (PAD), a Portable Media Player (PMP), a vehicle-mounted terminal (e.g., a vehicle-mounted navigation terminal), and a fixed terminal such as a digital television (TV), a desktop computer. The electronic device shown in FIG. 4 is merely one example and should not bring any limitation to the functions and the application scope of the embodiments of the present disclosure.

As illustrated in FIG. 4, the electronic device 40 may include a processing apparatus (e.g., a central processing unit, a graphics processing unit, etc.) 41 which can execute various proper actions and processing according to programs stored in a Read-Only Memory (ROM) 42 or programs loaded into a Random Access Memory (RAM) 43 from a storage apparatus 48. In the RAM 43, various programs and data required for the operation of the electronic device 40 are also stored. The processing apparatus 41, the ROM 42, and the RAM 43 are connected with each other through a bus 45. An Input/Output (I/O) interface 44 is also connected to the bus 45.

Generally, the following apparatuses may be connected to the I/O interface 44: an input apparatus 46 including, for example, a touch screen, a touch pad, a keyboard, a mouse, a camera, a microphone, an accelerometer, a gyroscope; an output apparatus 47 including, for example, a Liquid Crystal Display (LCD), a loudspeaker, a vibrator; a storage apparatus 48 including, for example, a magnetic tape, a hard disk; and a communicator 49. The communicator 49 can allow the electronic device 40 to perform wireless or wired communication with other devices so as to exchange data. FIG. 4 illustrates the electronic device 40 with various apparatuses, but it should be understood that it is not required to implement or have all the shown apparatuses. More or fewer apparatuses may be alternatively implemented or equipped.

Particularly, according to the embodiments of the present disclosure, the processes above described with reference to the flow charts can be implemented as computer software programs. For example, an embodiment of the present disclosure includes a computer program product which includes a computer program carried on a non-transitory computer readable medium. The computer program includes program codes for executing the method shown in the flow charts. In such embodiment, the computer program can be downloaded and installed from the network by the communicator 49, or installed from the storage apparatus 48, or installed from the ROM 42. When the computer program is executed by the processing apparatus 41, the functions above limited in the method provided by the embodiments of the present disclosure are executed.

The names of messages or information interacted among multiple apparatuses in the embodiments of the present disclosure are merely used for the illustrative purpose, but not used for limiting the scope of these messages or information.

The electronic device provided by the embodiment of the present disclosure and the method for generating the effect icon, as provided by the embodiments above, belong to the same inventive concept, the technical details which are not described in detail in this embodiment can refer to the embodiments above, and this embodiment has the same beneficial effects with the embodiments above.

### Embodiment V

An embodiment of the present disclosure provides a computer storage medium having stored thereon a computer program. When the program is executed by a processor, the method for generating the effect icon, as provided by the embodiments above, is implemented.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. Examples of the computer-readable storage medium may include but not be limited to: an electrical connection with one or more wires, a portable computer disk, a hard disk, a random-access memory (RAM), a read-only memory (ROM), an erasable programmable read-only memory (EPROM) or flash memory, an optical fiber, a compact disk read-only memory (CD-ROM), an optical storage device, a magnetic storage device, or any appropriate combination of them.

In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the method for generating effect icon described in the above embodiments.

The storage medium can a non-transitory storage medium.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

Involved units described in the embodiments of the present disclosure may be implemented in a software mode or may be implemented in a hardware mode, wherein names of the units do not constitute the limitation to the units and for example, a first acquisition unit may also be described as “a unit for acquiring at least two internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example I provides a method for generating an effect icon. The method includes: in response to an icon production operation for a target effect, displaying an icon production window for the target effect; receiving a picture selection operation and acquiring a selected original picture, the picture selection operation being selecting one picture in the icon production window; and processing the original picture, displaying a processed target picture, and using the processed target picture as a target effect icon, the target picture being a superposition of the original picture and an effect result corresponding to the target effect.

According to one or more embodiments of the present disclosure, Example II provides a method for generating an effect icon. The method includes: an effect preview interface is included in the effect production window for the target effect and the effect preview interface is presented through a pre-created effect preview instance; and

Correspondingly, the processing the original picture, displaying the processed target picture, and using the processed target picture as the target effect icon includes: adding the effect result of the target effect for the original picture and generating a target picture by a created icon generation thread and in combination with the effect preview instance; and displaying the target picture and using the target picture as the target effect icon of the target effect.

According to one or more embodiments of the present disclosure, Example III provides a method for generating an effect icon. In the method, the step of, adding the effect result of the target effect for the original picture and generating a target picture by a created icon generation thread and in combination with the effect preview instance may includes:
creating the icon generation thread; calling the effect preview instance based on a setting interface, converting the original picture into an original video frame, and inputting the original video frame into the effect preview instance, by the icon generation thread; and repeatedly executing an original video frame input operation by the icon generation thread, until an input end condition is satisfied, acquiring a target video frame output by the effect preview instance and using the target video frame as the target picture;
wherein the target video frame is a picture in which the effect result of the target effect is superposed on the original picture.

According to one or more embodiments of the present disclosure, Example IV provides a method for generating an effect icon. In the method, the step of, repeatedly executing an original video frame input operation by the icon generation thread, until an input end condition is satisfied, acquiring a target video frame output by the effect preview instance may include: determining a corresponding cumulative input number of times after executing the current input of the original video frame to the effect preview instance by the icon generation thread; if the cumulative input number of times does not reach a set cumulative threshold, re-executing an input operation from the original video frame to the effect preview instance; otherwise acquiring a video frame currently output by the effect preview instance and marking the video frame as the target video frame.

According to one or more embodiments of the present disclosure, Example V provides a method for generating an effect icon. In the method, the step of, repeatedly executing an original video frame input operation by the icon generation thread, until an input end condition is satisfied, acquiring a target video frame output by the effect preview instance may include: performing feature analysis on a current video frame correspondingly acquired by the effect preview instance, after executing the current input of the original video frame to the effect preview instance by the icon generation thread; if it is determined that an effect feature of the target effect result is included in the current video frame, acquiring the current video frame and marking the current video frame as the target video frame; otherwise re-executing the input operation from the original video frame to the effect preview instance.

According to one or more embodiments of the present disclosure, Example VI provides a method for generating an effect icon. In the method, the step of, repeatedly executing an original video frame input operation by the icon generation thread, until an input end condition is satisfied, acquiring a target video frame output by the effect preview instance may include: acquiring and displaying a current video frame output after the effect preview instance receives the currently input original video frame by the icon generation thread; if receiving a selection operation of a user relative to the current video frame, marking the current video frame as the target video frame; otherwise after receiving a continuous input operation triggered by the user, re-executing the input operation from the original video frame to the effect preview instance.

According to one or more embodiments of the present disclosure, Example VII provides a method for generating an effect icon. Before the step of, adding the effect result of the target effect for the original picture and generating a target picture by a created icon generation thread and in combination with the effect preview instance, the method may add: stopping an output of an effect preview video frame relative to the target effect from the effect preview instance to the effect preview interface.

According to one or more embodiments of the present disclosure, Example VIII provides a method for generating an effect icon. In the process of processing the original picture, the method may add a step: receiving a picture switching operation and acquiring a switched picture after switching, the picture switching operation being reselecting one picture in the icon production window; terminating processing on the original picture and using the switched picture as a new original picture; and re-executing processing on the original picture, displaying the processed target picture, and using the processed target picture as the target effect icon.

According to one or more embodiments of the present disclosure, Example IX provides a method for generating an effect icon. In the method, the step of terminating processing on the original picture may include: searching the created icon generation thread for executing processing on the original picture and modifying a thread run parameter in the icon generation thread; and in a case of detecting a change of the thread run parameter by the icon generation thread, terminating the thread run.

The embodiments of the present disclosure provide the method and apparatus for generating the effect icon, the device, and the storage medium. Association between the generated effect icon and the produced effect is effectively ensured.

It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for generating an effect icon, comprising:
in response to an icon production operation for a target effect, displaying an icon production window for the target effect;
receiving a picture selection operation and acquiring a selected original picture, the picture selection operation being selecting one picture in the icon production window; and
processing the original picture, displaying a processed target picture, and using the processed target picture as a target effect icon, the target picture being a superposition of the original picture and an effect result corresponding to the target effect.

2. The method according to claim 1, wherein an effect preview interface is comprised in a main effect production window for the target effect and the effect preview interface is presented through a pre-created effect preview instance; and
correspondingly, the processing the original picture, displaying the processed target picture, and using the processed target picture as the target effect icon comprises:
adding the effect result of the target effect for the original picture and generating a target picture by a created icon generation thread and in combination with the effect preview instance; and
displaying the target picture and using the target picture as the target effect icon of the target effect.

3. The method according to claim 2, wherein the adding the effect result of the target effect for the original picture and generating a target picture by a created icon generation thread and in combination with the effect preview instance comprises:
creating the icon generation thread;
calling the effect preview instance based on a setting interface, converting the original picture into an original video frame, and inputting the original video frame into the effect preview instance, by the icon generation thread; and
repeatedly executing an original video frame input operation by the icon generation thread, until an input end condition is satisfied, acquiring a target video frame output by the effect preview instance and using the target video frame as the target picture,
wherein the target video frame is a picture in which the effect result of the target effect is superposed on the original picture.

4. The method according to claim 3, wherein the repeatedly executing an original video frame input operation by the icon generation thread, until an input end condition is satisfied, acquiring a target video frame output by the effect preview instance comprises:
determining a corresponding cumulative input number of times after executing the current input of the original video frame to the effect preview instance by the icon generation thread;
in response to the cumulative input number of times not reaching a set cumulative threshold, re-executing an input operation from the original video frame to the effect preview instance; and
in response to the cumulative input number of times reaching the set cumulative threshold, acquiring a video frame currently output by the effect preview instance and marking the video frame as the target video frame.

5. The method according to claim 3, wherein the repeatedly executing an original video frame input operation by the icon generation thread, until an input end condition is satisfied, acquiring a target video frame output by the effect preview instance comprises:
performing feature analysis on a current video frame correspondingly acquired by the effect preview instance, after executing the current input of the original video frame to the effect preview instance by the icon generation thread;
in response to determining that an effect result feature of the target effect is comprised in the current video frame, acquiring the current video frame and marking the current video frame as the target video frame; and
in response to determining that the effect result feature of the target effect is not comprised in the current video frame, re-executing the input operation from the original video frame to the effect preview instance.

6. The method according to claim 3, wherein the repeatedly executing an original video frame input operation by the icon generation thread, until an input end condition is satisfied, acquiring a target video frame output by the effect preview instance comprises:
acquiring and displaying a current video frame output after the effect preview instance receives the currently input original video frame by the icon generation thread;
in response to receiving a selection operation of a user relative to the current video frame, marking the current video frame as the target video frame; and
in response to not receiving the selection operation of the user relative to the current video frame, after receiving a continuous input operation triggered by the user, re-executing the input operation from the original video frame to the effect preview instance.

7. The method according to claim 2, wherein before adding the effect result of the target effect for the original picture and generating a target picture by the created icon generation thread and in combination with the effect preview instance, the method further comprises:
stopping an output of an effect preview video frame relative to the target effect from the effect preview instance to the effect preview interface.

8. The method according to claim 1, wherein, during processing the original picture, the method further comprises:
receiving a picture switching operation and acquiring a switched picture after switching, the picture switching operation being re-selecting one picture in the icon production window;
terminating processing on the original picture and using the switched picture as a new original picture; and
re-executing the processing on the original picture, displaying the processed target picture, and using the processed target picture as the target effect icon.

9. The method according to claim 8, wherein the terminating processing on the original picture and using the switched picture as a new original picture comprises:
searching the created icon generation thread for executing processing on the original picture and modifying a thread run parameter in the icon generation thread; and
in response to detecting a change of the thread run parameter by the icon generation thread, ending the thread run.

10. (canceled)

11. An electronic device, comprising:
one or more processors; and
at least one storage apparatus, configured to store one or more programs, wherein, when the one or more programs are executed by the one or more processors, the one or more processors being enabled to implement a method for generating an effect icon, which comprises:
in response to an icon production operation for a target effect, displaying an icon production window for the target effect;
receiving a picture selection operation and acquiring a selected original picture, the picture selection operation being selecting one picture in the icon production window; and
processing the original picture, displaying a processed target picture, and using the processed target picture as a target effect icon, the target picture being a superposition of the original picture and an effect result corresponding to the target effect.

12. A non-transient computer readable storage medium, wherein a computer program is stored on the computer readable storage medium, and when where the computer program is executed by a processor, a method for generating an effect icon, which comprises:
in response to an icon production operation for a target effect, displaying an icon production window for the target effect;
receiving a picture selection operation and acquiring a selected original picture, the picture selection operation being selecting one picture in the icon production window; and
processing the original picture, displaying a processed target picture, and using the processed target picture as a target effect icon, the target picture being a superposition of the original picture and an effect result corresponding to the target effect.

13. The electronic device according to claim 11, wherein an effect preview interface is comprised in an effect production main window for the target effect and the effect preview interface is presented through a pre-created effect preview instance; and
correspondingly, the processing the original picture, displaying the processed target picture, and using the processed target picture as the target effect icon comprises:
adding the effect result of the target effect for the original picture and generating a target picture by a created icon generation thread and in combination with the effect preview instance; and
displaying the target picture and using the target picture as the target effect icon of the target effect.

14. The electronic device according to claim 13, wherein the adding the effect result of the target effect for the original picture and generating a target picture by a created icon generation thread and in combination with the effect preview instance comprises:
creating the icon generation thread;
calling the effect preview instance based on a setting interface, converting the original picture into an original video frame, and inputting the original video frame into the effect preview instance, by the icon generation thread; and
repeatedly executing an original video frame input operation by the icon generation thread, until an input end condition is satisfied, acquiring a target video frame output by the effect preview instance and using the target video frame as the target picture,
wherein the target video frame is a picture in which the effect result of the target effect is superposed on the original picture.

15. The electronic device according to claim 14, wherein the repeatedly executing an original video frame input operation by the icon generation thread, until an input end condition is satisfied, acquiring a target video frame output by the effect preview instance comprises:
determining a corresponding cumulative input number of times after executing the current input of the original video frame to the effect preview instance by the icon generation thread;
in response to the cumulative input number of times not reaching a set cumulative threshold, re-executing an input operation from the original video frame to the effect preview instance; and
in response to the cumulative input number of times reaching the set cumulative threshold, acquiring a video frame currently output by the effect preview instance and marking the video frame as the target video frame.

16. The electronic device according to claim 14, wherein the repeatedly executing an original video frame input operation by the icon generation thread, until an input end condition is satisfied, acquiring a target video frame output by the effect preview instance comprises:
performing feature analysis on a current video frame correspondingly acquired by the effect preview instance, after executing the current input of the original video frame to the effect preview instance by the icon generation thread;
in response to determining that an effect result feature of the target effect is comprised in the current video frame, acquiring the current video frame and marking the current video frame as the target video frame; and
in response to determining that the effect result feature of the target effect is not comprised in the current video frame, re-executing the input operation from the original video frame to the effect preview instance.

17. The electronic device according to claim 14, wherein the repeatedly executing an original video frame input operation by the icon generation thread, until an input end condition is satisfied, acquiring a target video frame output by the effect preview instance comprises:
acquiring and displaying a current video frame output after the effect preview instance receives the currently input original video frame by the icon generation thread;
in response to receiving a selection operation of a user relative to the current video frame, marking the current video frame as the target video frame; and
in response to not receiving the selection operation of the user relative to the current video frame, after receiving a continuous input operation triggered by the user, re-executing the input operation from the original video frame to the effect preview instance.

18. The electronic device according to claim 13, wherein before adding the effect result of the target effect for the original picture and generating a target picture by the created icon generation thread and in combination with the effect preview instance, the method further comprises:
stopping an output of an effect preview video frame relative to the target effect from the effect preview instance to the effect preview interface.

19. The electronic device according to claim 11, wherein, during processing the original picture, the method further comprises:
receiving a picture switching operation and acquiring a switched picture after switching, the picture switching operation being re-selecting one picture in the icon production window;
terminating processing on the original picture and using the switched picture as a new original picture; and
re-executing the processing on the original picture, displaying the processed target picture, and using the processed target picture as the target effect icon.

20. The electronic device according to claim 19, wherein the terminating processing on the original picture and using the switched picture as a new original picture comprises:
searching the created icon generation thread for executing processing on the original picture and modifying a thread run parameter in the icon generation thread; and
in response to detecting a change of the thread run parameter by the icon generation thread, ending the thread run.

21. The non-transient computer readable storage medium according claim 12, wherein an effect preview interface is comprised in an effect production main window for the target effect and the effect preview interface is presented through a pre-created effect preview instance; and
correspondingly, the processing the original picture, displaying the processed target picture, and using the processed target picture as the target effect icon comprises:
adding the effect result of the target effect for the original picture and generating a target picture by a created icon generation thread and in combination with the effect preview instance; and
displaying the target picture and using the target picture as the target effect icon of the target effect.
